(19) United States
(12) Patent Application Publication
(10) Pub. No.: US 2004/0170860 A1
(43) Pub. Date: Sep. 2, 2004

(54) Method of producing metal composite materials comprising incompatible metals

(76) Inventors: Roy Hardwick, Troon (GB); Harry Sildva, Kirkfield (CA)

Correspondence Address: MANELLI DENISON & SELTER, 2000 M STREET NW SUITE 700, WASHINGTON, DC, 20036-3307, US

(21) Appl. No.: 10/778,084

(22) Filed: Feb. 17, 2004

(30) Foreign Application Priority Data
Feb. 17, 2003 (CA) 2,420,117

(51) Int. Cl. B32B 15/00

(52) U.S. Cl. 428/660; 428/684; 428/662; 228/235.2

(57) ABSTRACT

A method of making a multi-layered composite material having a layer of a first metal and a layer of a second incompatible metal, separate from the first metal, the method involving hot rolling a multi-layered assembly of the first metal; the second metal; and a composite interlayer between the first metal and the second metal; wherein the composite interlayer having a first outer layer of a first composite metal compatible with the first metal; a second outer layer of a second composite metal compatible with the second metal; and an interlayer metal bonded between the first composite metal and the second composite metal; and wherein the first metal is adjacent the first composite metal and the second metal is adjacent the second composite metal; to effect production of the multi-layered composite material. The invention is valuable for producing a bonded composite of a hardened steel, such as an armour steel, with GA14V titanium.

### FIELD OF THE INVENTION

This invention relates to the manufacture of clad metal composite materials. comprising two metals, incompatible one with the other, having an intervening composite layer between said incompatible metals.

### BACKGROUND TO THE INVENTION

Explosive bonding is generally accepted as the most versatile of metal joining processes because of its ability to metallurgically bond dissimilar metals which are incompatible by other joining processes such as, for example, fusion welding or diffusion bonding. To be capable of being explosively bonded, however, metals need to have good impact properties and an acceptable level of ductility and elongation. Consequently, there remain some combinations of materials which cannot be bonded one or both metals have mechanical properties not suitable for explosive bonding.

One example not conducive to explosive bonding is the bonding of certain grades of titanium and steel. While it is not possible to bond titanium to steel, directly, by fusion welding or diffusion bonding, these metals can be readily explosively bonded. However, in the case of 6A14V titanium and hardened steel, such as armour steel, these cannot be explosively bonded in their final required metallurgical condition. This is because the extremely high strength of both the 6A14V titanium and the armour steel requires very high explosive loads to overcome the high yield strength of the materials which, consequently, impose impact loads upon the armour steel which it cannot withstand because of its brittleness. Although these materials might well be capable of being explosively bonded in a pre—but not their final required metallurgical condition, that condition cannot then be subsequently acquired by the usual prior art heat treatment processes, because such heating causes the growth of brittle Ti/Fe intermetallics at the interfere as to cause unacceptable bond deterioration and/or disbonding.

U.S. Pat. No. 6,296,170 B1—Sigmabond Technologies Corporation, published 2 Oct. 2001, discloses inter alia the use of niobium as an interlayer in an explosively bonded composite slab of titanium and steel which is then capable of being hot rolled or extruded at temperatures above 900° C. to from clad sheet or tubular components. It has now been discovered that features of this method are capable of being used to enable the joining of metal combinations.

There is a need, therefore, to offer a method of manufacture of a composite material having a distinct layer of each of otherwise, incompatible metals which cannot be bonded by known means, including the process of explosive bonding.

### SUMMARY OF THE INVENTION

It is an object of the present invention to provide a method of bonding combinations of materials which are unsuitable for explosive bonding in their required metallurgical state but whose desired properties can be subsequently acquired by hot rolling and/or heat treatment.

A further object is to provide a less costly and more reliable method of bonding material combinations which can only be explosively bonded with great difficulty and to also leave the bonded composite free of the inherent defects which otherwise result from the explosive bonding of these materials such as shear cracks and brittle intermetallics associated with the explosively bonded interface.

It is a further object to provide a composite material as defined by a method according to the aforesaid methods.

Accordingly, in one aspect the invention provides a method of making a multi-layered composite material having a layer of a first metal and a layer of a second incompatible metal, separate from said first metal, said method comprising hot rolling a multi-layered assembly of said first metal; said second metal; and a composite interlayer between said first metal and said second metal; wherein said composite interlayer comprises a first outer layer of a first composite metal compatible with said first metal; a second outer layer of a second composite metal compatible with said second metal; and an interlayer metal bonded between said first composite metal and said second composite metal; and wherein said first metal is adjacent said first composite metal and said second metal is adjacent said second composite metal; to effect production of said multi-layered composite material.

Preferably, the first metal is an extremely high strength steel, such as an armoured steel, and the second metal is an extremely high strength titanium, such as GA14V.

A typical compatible first composite metal would be a carbon or stainless steel and a second composite metal would be titanium, zirconium or alloy thereof.

A preferred interlayer metal is niobium, tantalum, vanadium or alloy thereof.

A preferred method according to the invention may be achieved by firstly following the method described hereinbefore in U.S. Pat. No. 5,296,170 B1 and explosively bonding a composite of commercially pure titanium and low carbon steel having a niobium interlayer followed by hot rolling of that bonded composite material to form a thin composite interlayer. Suitable materials which are incompatible with each other but compatible for roll bonding with either the titanium or steel surfaces of the composite interlayer can now, thus, be roll bonded to form a further composite material which, primarily, consists of the two previously incompatible materials between which is, most preferably, an insignificant thickness of the original composite tertiary interlayer of steel/niobium/titanium. The presence of the niobium layer, however, which facilitated the hot rolling of initially, the interlayer and, subsequently, the second rolling of the incompatible materials, is now equally capable of facilitating any subsequent heat treatment which is necessary to attain the final desired properties of the added materials which have been bonded to the composite tertiary interlayer containing the niobium.

An example of the method according to the invention is now presented in more detail, as follows.

First, commercial titanium and carbon steel and an interlayer of niobium are bonded by the method of U.S. Pat. No. 6,296,170 B1 in the form of a slab, which is then hot rolled by conventional techniques at temperatures above 900° to provide a composite having a thin interlayer. This composite is now considered as a whole as a secondary interlayer in its own right and then incorporated in a loose composite assembly between thicker components of hardenable armour steel and 6A14V titanium. This loose composite assembly is now hot rolled to effect a roll bond between the component layers with the niobium element of the composite interlayer preventing the growth of brittle Ti/Fe intermetallics. The component layers of the loose composite assembly are now able to bond together during hot rolling because, in his instance, the roll bonding occurs at the similar interfaces between 6A14V titanium and the commercial titanium of the interlayer, and hence they are compatible, and also between the hardenable steel and the carbon steel which are equally compatible.

Having completed the bonding of the two hitherto incompatible metals in this manner, the desired mechanical properties of the armour steel can be achieved by subsequent suitable heat treatment because the niobium contained in the composite interlayer prevents any titanium and iron contact during the heat treatment in the same way that it allowed the initial slab to be hot rolled and, in the same manner, prevent the formation of brittle Ti/Fe intermetallic which would otherwise cause disbonding.

The method is equally applicable to the production of extruded tubes, for example, of 6A14V titanium and hardened steel by first explosively bonding a composite billet of commercial grade titanium to carbon steel having a niobium interlayer and extruding this into the form of a thin walled ‘shell’ or tube. This interlayer tube is then assembled between thicker tubular components of the 6A14V titanium and armour steel to form a loose composite tubular billet which is then hot extruded into tubular form and provide bonding of the layers of the composite billet together, concomitantly.

A significant advantage of the present invention is that, despite the fact that the heat treated composite plate or tube which is ultimately produced is disposed between essentially brittle materials, the bond between the dissimilar metals will itself remain ductile as that bond is between the more ductile commercial titanium and the carbon steel and also contains the very ductile niobium layer.

A further significant advantage of the present invention is that a composite material so produced is also superior to composite components which are not metallurgically bonded as, for instance, the case of a 6A14V titanium and armour steel composite in which the titanium tube is mechanically expanded within the armour steel tube or the steel tube is contracted on to the titanium tube. In such a case there is only mechanical contact between the components and only limited heat transfer can take place across such an interface. Consequently, heat dissipation from the bore of the tube to the outside of the tube is much slowed and hot gases or liquids within the tube will more quickly heat the lining of the unbonded composite component and, conversely, either natural or forced cooling of the component from the outside is less effective in cooling the bore component metal. Such a tube is effective in providing the necessary structural strength for its intended purpose because of the strength of the armour steel while the 6A14V titanium provides corrosion resistance to any hot gases or liquids which may exist in the tube bore.

The method of the invention is not limited to fabrication and joining of brittle metals which are alloys of the titanium and steel composite interlayer as other metallic elements which are compatible for roll bonding to these materials are equally viable materials. For example, it is possible to join stainless steel or chrome to a 6A14V Ti substrate by the method according to the present invention, in either plate or tubular form. This is because it is demonstrable that stainless or chromium can be roll bonded or extrusion bonded to steel. Hence, an explosively bonded carbon or stainless steel/niobium/titanium tubular interlayer can be interposed between a stainless steel or chromium liner and a 6A14V Ti outer substrate tube and then co-extruded to bond and form a very strong and lightweight composite tube which is principally a titanium tube but having a wear resistant liner of chromium or stainless steel. Such a tube would be invaluable in applications where light weight is a prime consideration but which involves surfaces which must be wear and/or corrosion resistant. Examples are a titanium bush lined with chrome which can be incorporated in a titanium superstructure or in the construction of lightweight hydraulic equipment. Other applications are seen where portability of such a tube is also a consideration, for example, in the design of lighter armaments, but with the greatest value being in the fields of aerospace, air manufacture and military applications where designs of this nature could not be considered previously because of the inability to join these materials.

The method according to the present invention makes it possible to produce composite tubes and plates for use in fields of application where lightweight, high strength, corrosion and wear resistance and portability are critically important requirements, and where the means of joining and producing these composites did not previously exist.

Thus, the present invention provides a method of bonding high strength titanium or titanium alloys to high strength steels which cannot be bonded conventionally by explosive bonding because of their mechanical properties which cause failure of the metal under the stresses of bonding. Bonding of these metals is, thus, achieved by explosively bonding any form of titanium and steels which have suitable mechanical properties for explosively bonding and between which is interposed an interlayer of, for example, niobium, tantalum or vanadium; to prevent the growth of intermetallics during any subsequent heating of the composite material. As mentioned hereinabove, the interlayer may be of flat sheet or cylindrical form. This composite is hot rolled or extruded at temperatures above 900° C. to produce a thin composite secondary interlayer. After cooling, this secondary interlayer is interposed between a layer of high strength titanium and a layer of high strength steel with the high strength titanium being adjacent to the titanium surface of the composite interlayer and, similarly, the high strength steel being adjacent to the steel surface of the composite secondary interlayer to produce a loose composite assembly. This assembly is hot rolled or extruded at temperatures above 900° C. to bond the component layers together, wherein the high strength titanium and the high strength steel, respectively, bond to the like material at the surfaces of the explosively bonded composite secondary interlayer under the heat and pressure of the rolling or extrusion process. The resulting sheet or tubular composite is suitable for any subsequent heat treatment that may be required to obtain the desired mechanical properties in both or either of the high strength steel or high strength titanium component layers.

The method, according to the invention, is not limited to the bonding of high strength titanium and high strength steel as one or the other of these differing metals may be of lower strength material.

The method is also not limited to titanium and steel materials, but may also be used to join other materials which are capable of bonding under heat and pressure to the materials of the interlayer.

### BRIEF DESCRIPTION OF THE DRAWINGS

In order that the invention may be better understood preferred embodiments will now be described by way of example only, with reference to the accompanying drawings, wherein

FIG. 1 is a diagrammatic cross-section of a loose composite assembly of metal component layers in planar form prior to roll bonding according to the invention;

FIG. 2 is a diagrammatic cross-section of the bonded assembly of FIG. 1 after roll bonding, according to the invention;

FIG. 3 is a diagrammatic cross-section of a loose composite assembly of metal component layers in tubular form prior to roll bonding according to the invention;

FIG. 4 is a diagrammatic cross-section of the bonded assembly of FIG. 3 after roll bonding according to the invention; and wherein the same numerals denote like parts.

### DETAILED DESCRIPTION OF THE INVENTION

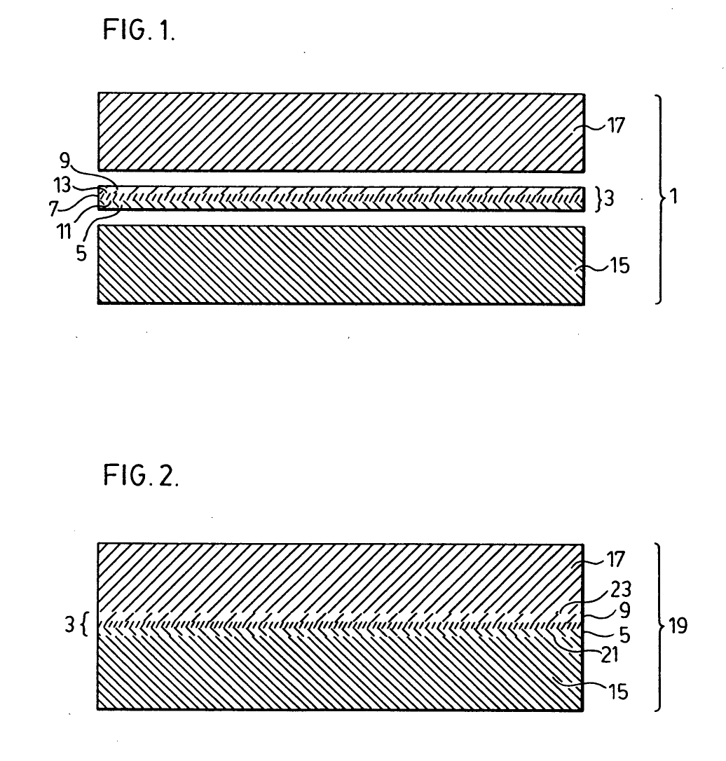

FIG. 1 illustrates the method of the present invention as it is applicable to the production of sheet or plate materials by hot rolling. The drawing shows generally as 1 a loose pack assembly suitable for hot rolling and consisting of a composite bonded interlayer 3 containing a first layer of carbon or stainless steel 5, a second or interlayer of niobium 7 and a third layer of grade one titanium 9 having an explosive bond 11 joining layer of steel 5 to the niobium 7, and a second explosive bond 13 joining the niobium 7 to the titanium 9. This composite bonded interlayer 3 termed herein as a whole a “secondary interlayer” is produced initially as a slab by known explosive bonding techniques and is then hot rolled down to produce the thinner secondary interlayer 3 by the general method described in aforesaid U.S. Pat. No. 6,296,170 B1. Secondary interlayer 3 is interposed between a layer of alloy steel 15 and a layer of high strength titanium alloy 17, wherein steel alloy 15 is capable of acquiring its required high strength properties by subsequent and suitable heat treatment.

The assembled pack 1 is sealed by conventional methods to be available for hot rolling, which hot rolling operation results in further and total bonding of the component layers of the pack assembly 1.

FIG. 2 show shows the totally bonded composite plate 19 which is now of reduced thickness and greater area with additional bonding resulting from the hot rolling operation being a hot rolled bond 21 between the hardenable steel alloy 15 and the carbon or stainless steel 5 of the explosively bonded composite 3 and a roll bond 23 between the high strength titanium alloy 17 and the grade one titanium 9 of the explosively bonded composite secondary interlayer 3.

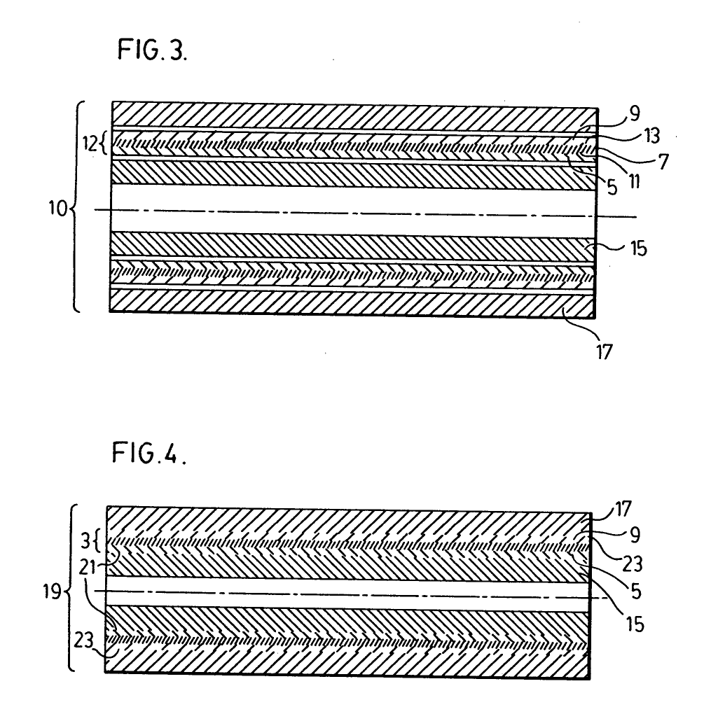

FIG. 3 illustrates the method of the present invention as it is applicable to the production of bonded composite tubular components by hot extrusion. The drawing shows a loose composite billet 10 suitable for hot extrusion which consists of an explosively bonded composite tube or shell 12 containing a first inner layer of carbon or stainless steel 5, a second and central layer of niobium 7 and a third outer layer of grade one titanium 9 having an explosive bond 11 joining the first layer of steel 5 to the niobium 7 and a second explosive bond 13 joining the niobium 7 to titanium 9. This composite bonded tube 12 is produced initially as an explosively bonded billet by known explosive bonding techniques and is then hot extruded and drawn down or pilgered by conventional techniques to produce the thinner composite tube 12 by the method of U.S. Pat. No. 6,296,170 B1. The explosively bonded composite tube 12 is interposed between an inner tubular layer or rod of alloy steel 15 and a tubular outer layer of high strength titanium alloy 17, wherein steel alloy 15 is capable of acquiring its required high strength properties by subsequent and suitable heat treatment. The assembled billet 10 is sealed at the various interfaces by conventional methods to be available for hot extrusion. The hot extrusion operation results in further and total bonding of the component layers of the billet assembly 10.

FIG. 4 show shows the totally bonded composite tube 19, which is now of reduced thickness and greater length with additional bonding resulting from the hot extrusion operation being a hot extruded bond 21 between the hardenable steel alloy 15 and the carbon or stainless steel 5 of the explosively bonded composite tube 12 and a hot extruded bond 23 between the high strength titanium alloy 17 and the grade one titanium 9 of the explosively bonded composite tube 12.

### EXAMPLE 1

A 5 mm thick sheet of low carbon steel and a 19 mm thick sheet of grade one titanium, incorporating there between a 1 mm thick sheet of niobium was explosively bonded to provide a composite clad. This clad was duplicated and the two clads were assembled face to face with the titanium adjacent and a parting agent disposed between the two to prevent bonding of these surfaces when hot rolling. A 12.5 mm thick steel plate was placed on each outside surface of this assembly. This steel was designed to roll bond to the 6 mm thick steel of the explosively bonded composite to give a composite thickness of 37.5 mm to each of the two assemblies. The two slabs were then hot rolled at a temperature of 1050° C. whereby each slab was reduced in thickness to 3 mm and with simultaneous roll bonding of the steel plate to the steel of the explosively bonded composite. This augmented the steel thickness relative to that of the titanium and effectively increasing the proportion of steel in the final composite.

A portion of this interlayer material was then interposed between two 10 mm thick plates, one being of type 4340 steel and the other being 6A14V titanium alloy. The 6A14V titanium alloy was placed adjacent to the titanium surface of the composite interlayer and the type 4340 steel being adjacent to the carbon steel surface of the composite interlayer.

The assembly was hot rolled to bond the carbon steel of the composite interlayer to the type 4340 steel and the grade 1 titanium of the interlayer to the 6A14V titanium. The final rolled sample was of 2.4 mm thickness.

A sample of this rolled plate satisfactorily withstood compression and tensile bend tests at a bend radius of 0·5 t. The plate was heated to approx. 1100° C. without disbonding to confirm the effectiveness of the niobium, now of only 8 microns thickness, in its ability to withstand high heat treatment temperatures. After this heating the material again withstood compression and tensile bend tests at a bend radius of 0·5 t.

### EXAMPLE 2

A portion of the same interlayer material produced for Example 1 was interposed between a 16 mm thick plate of stainless steel and a 10 mm thick plate of 6A14V titanium. The carbon steel surface of the composite interlayer being disposed adjacent to the stainless steel plate, with which it is compatible for roll bonding, and the titanium surface of the composite interlayer being adjacent to the 6A 14V titanium alloy.

This assembly was hot rolled at a temperature of 1050° C. and reduced in thickness to 4.5 mm.

After rolling, the composite was found to have been effectively bonded to form a composite having exterior surfaces of stainless steel and 6A14V titanium alloy.

The composite was again heated to 1100° C. without disbanding to prove the effectiveness of the niobium interlayer at its final thickness of 12 microns.

### EXAMPLE 3

Table I in alternative embodiments lists the natures of the two incompatible metals as layer 17 and layer 15 as described with reference to FIGS. 1 and 2 and made as hereinabove described with reference to FIGS. 1 and 2.

TABLE

| First Metal (17) | Second Metal (15) | Composite (3) |
|---|---|---|
| Ductile steel alloy | GA14 V Titanium | Carbon Steel/Nb/ductile Ti |
| Lower strength ductile | Armoured steel | Carbon Steel/Nb/ductile Ti |
| titanium | | |

Although this disclosure has described and illustrated certain preferred embodiments of the invention, it is to be understood that the invention is not restricted to those particular embodiments. Rather, the invention includes all embodiments which are functional or mechanical equivalents of th specific embodiments and features that have been described and illustrated.

1. A method of making a multi-layered composite material having a layer of a first metal and a layer of a second incompatible metal, separate from said first metal, said method comprising hot rolling a multi-layered assembly of said first metal; said second metal; and a composite interlayer between said first metal and said second metal; wherein said composite interlayer comprises a first outer layer of a first composite metal compatible with said first metal; a second outer layer of a second composite metal compatible with said second metal; and an interlayer metal bonded between said first composite metal and said second composite metal; and wherein said first metal is adjacent said first composite metal and said second metal is adjacent said second composite metal; to effect production of said multi-layered composite material.

2. A method as defined in claim 1 wherein said first metal and said second metal are incompatible by reason that they are unsuitable for explosive bonding directly, one to the other, to provide either directly or indirectly bonded composite material having desired bond properties.

3. A method as defined in claim 1 wherein said first metal is an extremely high strength steel.

4. A method as defined in claim 1 wherein said steel is a hardened steel.

5. A method as defined in claim 1 wherein said first metal is a ductile steel alloy.

6. A method as defined in claim 1 wherein said second metal is an extremely high strength metal selected from the group consisting of titanium, zirconium and alloys thereof.

7. A method as defined in claim 1 wherein said second metal is a lower strength ductile metal selected from the group consisting of titanium, zirconium and alloys thereof.

8. A method as defined in claim 6 wherein said titanium is GA14V.

9. A method as defined in claim 1 wherein said first composite metal is a carbon steel or a stainless steel.

10. A method as defined in claim 1 wherein said second composite metal is selected from the group consisting of a ductile titanium, zirconium and alloys thereof.

11. A method as defined in claim 1 wherein said interlayer metal is selected from the group consisting of niobium, tantalum, vanadium and an alloy thereof.

12. A method as defined in claim 1 further comprising heat treating said multi-layered composite material to an elective temperature to import desired physical properties and produce treated composite material.

13. A multi-layered composite material made by a method as defined in claim 1.
